(19) United States
(12) Patent Application Publication
(10) Pub. No.: US 2009/0224885 A1
(43) Pub. Date: Sep. 10, 2009

(54) RADIO FREQUENCY IDENTIFICATION READER DATA INTEGRATION DEVICE AND METHOD THEREOF

(75) Inventors: Chen-Jyh Fan, Hsinchu County (TW); Shu-Ju Hsieh, Taichung County (TW); Da-Wei Kuo, Kaohsiung City (TW); Chun-Te Yu, Yunlin County (TW); Ching-Tsung Cheng, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/128,616

(22) Filed: May 29, 2008

(30) Foreign Application Priority Data
Mar. 4, 2008 (TW) 97107487

(51) Int. Cl. H04Q 5/22

(52) U.S. Cl. 340/10.1

(57) ABSTRACT

A Radio Frequency Identification (RFID) reader data integration device and a method thereof are provided. The RFID data integration device records the communication protocols, the control instructions of the RFID readers manufactured by any factory and the interpretive program in the central control chip, so as to correctly read the first data in order to achieve the effect of real-time monitoring. The RFID data integration device then performs the data processing on the received data according to the interpretive program recorded in the central control chip.. The RFID reader data integration device may transmit information of the RFID readers to a back-end terminal machine. Thus the RFID reader data integration device can simplify the environment of the RFID application and raise the popularity of RFID.

### CROSS-REFERENCE TO RELATED APPLICATION

This application claims the priority benefit of Taiwan application serial no. 97107487, filed on Mar. 4, 2008. The entirety of the above-mentioned patent application is hereby incorporated by reference herein and made a part of this specification.

### BACKGROUND OF THE INVENTION

1. Field of the Invention

The present invention generally relates to a radio frequency identification (RFID) reader data integration device and a method thereof, in particular, to a data integration device capable of monitoring an RFID reader manufactured by any factory and a method thereof.

2. Description of Related Art

RFID systems are comprised of RFID readers and tags. The tag where the data of an object is stored is attached onto the object. The RFID readers transmit or receive the data on the tag by means of electromagnetic waves and transmit the data to a back-end terminal machine for processing. In general, the terminal machine is a personal computer (PC) or a server.

Currently, in use of the RFID, the information of the tag cannot be normally read unless the RFID reader is selected and the PC is used for processing. Thus, the reader cannot be monitored in real-time for reading the information. Moreover, no standard protocols about the hardware of the RFID have been established, so the readers manufactured by different factories must be integrated in the course of the system building and application. Therefore, the user needs to write different drivers for the readers manufactured by different factories, which is time and labor consuming in writing programs and increases the complexity of the system. Moreover, when a large amount of data information needs to be transmitted, the load of the PC is heavy, and thus the PC is easily shut down or the loss of data often occurs, which decreases the stability of the system.

Referring to ROC Publication No. 200632705, a system, method, and software architecture for developing and building an RFID software application platform is disclosed. The platform is the architecture between the applications and the physical RFID readers connected thereto. The runtime version of the platform may be regarded as a logical RFID reader. The platform allows the RFID applications to communicate with the physical RFID readers securely, so as to monitor the statuses of the RFID readers and access the RFID tags' data. The platform contains multiple externalized application programming interfaces (APIs), an event manager, a data manager, and a device manager. The APIs are used for accessing the tag data. The event manager is used for warning the application events coming from the REID readers and the RFID tags. The data manager is used for filtering and modulating the data returned from the physical RFID readers before responding the applications. The device manager is used for monitoring the statuses of the RFID readers, thereby managing the RFID readers and the secure communication channel with data encryption.

In view of the above, ROC Publication No. 200632705 uses the system platform to monitor, manage, and control the statuses of the physical RFID devices, presentation adjustments, and device-specific parameters, and data flows among the physical RFID devices.

Then, referring to US Publication No. US 2007/0046467 A1, multiple sets of RFID readers are coordinated to achieve consistency in this invention. The system and method of this invention may decrease the interference among the RFID readers and improve the performance of the RFID readers. According to the system and method, the first setting is directed to adjusting the conversion and transmission of information into a single mode for a single RFID reader or multiple sets of RFID readers. The second setting is directed to adjusting the receiving into a single mode for the single RFID reader or multiple sets of RFID readers. The cycle of information conversion and transmission in the first setting and the cycle of the receiving mode in the second setting must be coordinated to achieve consistency.

In view of the above, US Publication No. 2007/0046467 A1 provides a system and method for setting adjustments, so as to make the sets of RFID readers to be coordinate, thereby improving the reading performance.

Finally, referring to US Publication No. 7245220 B2, a software interface is used to complete the function of controlling every set of RFID readers. Therefore, various different RFID reader drivers are required to be installed in the controller of this invention, so as to achieve the function of controlling various different RFID readers.

Although the above devices or methods may solve some problems encountered in the application of RFID, the construction of the entire system costs a larger amount of money, more time and labor resources. Also, spending more time and labor resources for the development of the software goes against the economic efficiency and manufacturing cost.

### SUMMARY OF THE INVENTION

Accordingly, the present invention is directed to an RFID reader data integration device. The data integration device may record communication protocols, control instructions of RFID readers manufactured by any factory and the interpretive program, for controlling the readers manufactured by any factory without additionally developing a user interface program. A display module is used to monitor information read by the readers in real time.

The present invention provides an RFID reader data integration device for controlling at least one RFID reader. The data integration device includes a communication interface, an output interface, a transceiver, and a processor. The communication interface is used for communicating with the RFID reader. The output interface is used for outputting a second data. The transceiver is coupled to the communication interface and the output interface, for receiving a first data sent by the RFID reader and transmitting the second data to the output interface. The processor is coupled to the transceiver and has a central control chip. The central control chip is used for recording interpretive program and communication protocols and control instructions of the RFID reader. The processor may perform a data processing on the first data to convert the first data into the second data according to the interpretive program.

The present invention provides an RFID reader control method, for controlling at least one RFID reader. A central control chip and a communication interface are provided. The central control chip is used for recording interpretive program and communication protocols and control instructions of a plurality of different RFID readers. The communication interface is used for communicating with the externally connected RFID reader, for receiving a first data of the RFID reader. A processor may perform a data processing on the first data to convert the first data into a second data according to the interpretive program recorded in the central control chip. Finally, the second data is output to a back-end device.

In view of the above, the data integration device according to the embodiments of the present invention and the data integration device using the control method according to the embodiment of the present invention may control at least one RFID reader manufactured by any factory. The data integration device records the communication protocols, the control instructions of the RFID readers manufactured by any factory and the interpretive program in the central control chip, so as to correctly read the first data in order to achieve the effect of real-time monitoring. The data integration device then performs the data processing on the received data according to the interpretive program recorded in the central control chip.

In order to the make aforementioned and other objects, features and advantages of the present invention comprehensible, preferred embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit block diagram of an RFID reader data integration device according to an embodiment of the present invention.

FIG. 2 is a systematic block diagram of an RFID reader data integration device according to an embodiment of the present invention.

FIG. 3 is a flow chart illustrating processes of an RFID reader control method according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In order to make the present invention more comprehensible, the RFID reader data integration device provided in the present invention will be illustrated below in accompanying with the drawings and the embodiments.

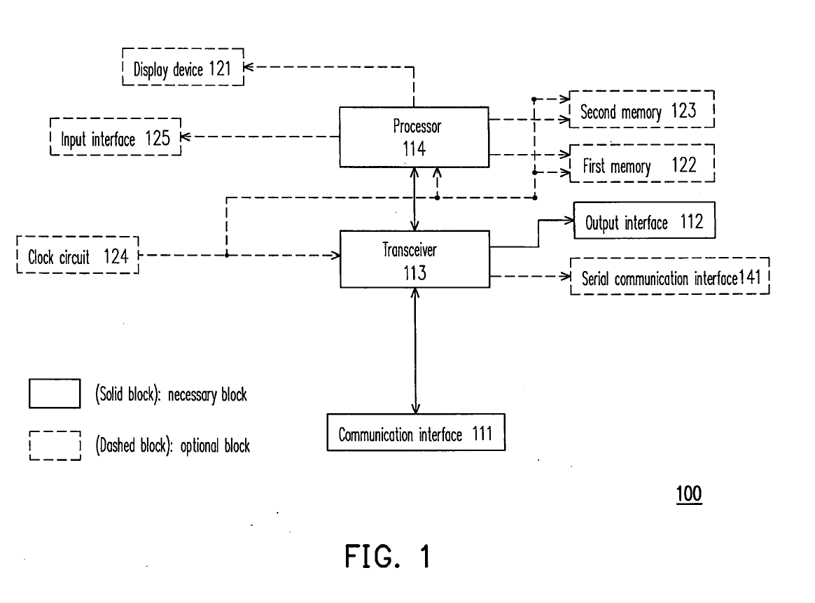

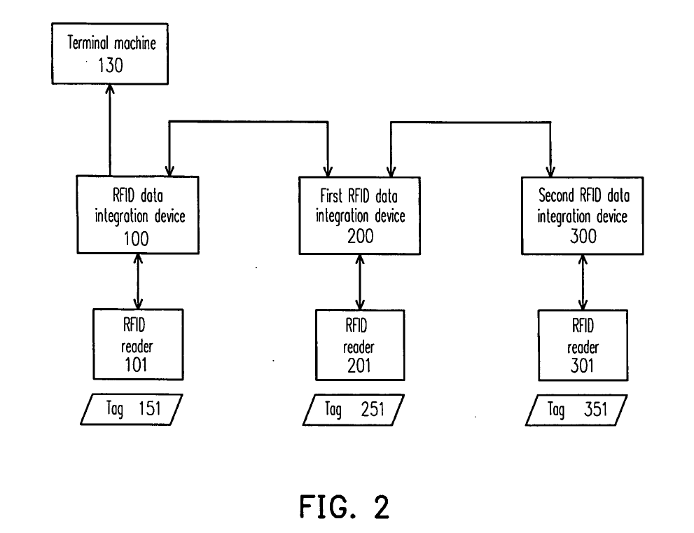

FIG. 1 is a circuit block diagram of an RFID reader data integration device 100 according to an embodiment of the present invention. Referring to FIG. 1, the data integration device 100 essentially includes a communication interface 111, an output interface 112, a transceiver 113, and a processor 114. The communication interface 111 may be a recommended standard 232 (RS232) interface, a recommended standard 485 (RS485) interface, or a network interface. However, the implementation of the communication interface 111 is not intended to limit the scope of the present invention. As shown in FIG. 2, the communication interface 111 of the data integration device 100 is externally connected to an RFID reader 101, and the output interface 112 is externally connected to a terminal machine 130.

Referring to FIGS. 1 and 2, the communication interface 111 is coupled to the RFID reader 101. The transceiver 113 is coupled to the communication interface 111. The output interface 112 and the processor 114 are coupled to the transceiver 113. The communication interface 111 is used for communicating with the RFID reader 101. The transceiver 113 is used for receiving a first data sent by the RFID reader 101 and transmitting a second data to the output interface 112. The processor 114 has a central control chip. The central control chip is used for recording the communication protocols and control instructions of RFID readers 101 of various specifications and the interpretive program for filtering the data. Furthermore, a corresponding tag of the RFID reader 101 is tag 151 and the first data carrying information is stored in the tag 151.

First, the RFID reader 101 reads the first data of the tag 151. The communication interface 111 transmits the first data captured from the tag 151 by the RFID reader 101 to the transceiver 113. The transceiver 113 receives the first data from the tag 151 via the communication interface 111 and transmits the first data to the processor 114 for processing. After processing, the second data is generated and then transmitted to the output interface 112 by the transceiver 113. The processor 114 performs a data processing on the first data according to the interpretive program recorded in the central control chip, thereby filtering a large amount of undesired or repetitive first data and converting it into the second data. Finally, the second data will be sent to the back-end terminal machine 130 via the output interface 112 for the final processing and storage. The RFID reader 101 and the tag 151 have their respective operating frequency bands. However, the operating frequency bands are not intended to limit the scope of the present invention.

Since the central control chip of the processor 114 is used for recording the communication protocols and the control instructions of a plurality of different RFID readers manufactured by any factory (having different specifications), regardless of which brand (or specifications) is selected, the receiving and controlling of the RFID readers 101 can function normally. In other words, as long as the communication protocols and the control instructions of the selected RFID reader 101 are recorded in the central control chip, the data integration device 100 may be utilized to communicate with and control the RFID reader 101. The central control chip is configured in the processor 114 in this embodiment, which is not intended to limit the scope of the present invention. That is to say, the central control chip may be configured freely as long as being coupled to the data integration device 100.

Moreover, the RFID reader data integration device 100 may provide a serial communication interface 141. As long as the externally connected first RFID reader data integration device 200 also has a first serial communication interface, the RFID reader data integration device 100 may communicate with the first RFID reader data integration device 200 via the serial communication interface 141 and the first serial communication interface 241. The implementation and function of the first serial communication interface 241 is similar to those of the serial communication interface 141. Similarly, the RFID reader data integration device 100 may also communicate with a second RFID reader data integration device 300 via the connection of the first and second RFID data integration devices 200 and 300. That is to say, the RFID reader data integration device 100 may communicate with a plurality of same RFID reader data integration devices.

However, the plurality of same RFID reader data integration devices are not required to be individually connected to the terminal machines via the output interfaces to process and store the second data. Instead, the second data is gathered in one of the RFID reader data integration devices via the serially connected communication interfaces, and the RFID reader data integration device, for example, the RFID reader data integration device 100 as shown in FIG. 2 where the second data is gathered is coupled to the terminal machine.

The respective second data of the RFID reader data integration devices will all be sent to a single terminal machine via the serially connected communication interfaces instead of being processed and stored individually by the respective terminal machines. Therefore, the RFID reader data integration device of the embodiment of the present invention may achieve the effect of overall control.

Therefore, a plurality of RFID readers 101, 201, 301, etc. manufactured by any factory may be select at a time in the embodiment of the present invention. Since different first data corresponds to a different communication protocol, the respective processor may individually process the first data captured by RFID readers 101, 201, and 301 according to the interpretive program recorded in the central control chip. Therefore, besides the brand (or specification) of the RFID readers 101, 201, and 301, the number of the RFID readers is also not limited in this embodiment. Regardless of how many RFID readers are used, only one terminal machine can process the plurality of different RFID readers.

In addition, the data integration device 100 further includes a display device 121 coupled to the processor 114. The display device 121 may be used for displaying the first data captured by the RFID reader 101 manufactured by any factory, thereby achieving the function of real-time control, other than being monitored at the back-end terminal machine 130, thus saving labor resources. This display device 121 may be a liquid crystal display device, CRT display device, or other device with a display function.

In addition, the data integration device 100 further includes a first memory 122, a second memory 123, and a clock circuit 124. The first memory 122 is coupled to the processor 114, for temporarily storing the first data. The second memory 123 is also coupled to the processor 114, for temporarily storing the second data. Since the first memory 122 and the second memory 123 may be used for temporarily storing the data, even if a large amount of the first data or the second data needs to be transmitted or received, a buffering effect may be achieved, and thus the processing capacity of the processor 114 will not be exceeded or the loss of data will not occur. The clock circuit 124 is coupled between the transceiver 113, the processor 114, the first memory 122, and the second memory 123. The clock circuit 124 is used for controlling an operating time for temporarily storing the first data and the second data, generating the second data, and transmitting or receiving the first data and the second data to enable the processor 114 to achieve the buffering effect.

Furthermore, the data integration device 100 further includes an input interface 125 coupled to the processor 114. The input interface 125 is used for setting the communication interface 111, such that the communication interface 111 communicates with the RFID reader 101. The input interface 125 may be further used for updating the interpretive program and the communication protocols and the control instructions of the RFID reader 101 manufactured by any factory recorded by the central control chip in the processor 114. Thus, the RFID reader 101 may be replaced without changing the RFID reader data integration device 100. Therefore, the present data integration device 100 may record and update the communication protocols and the control instructions of the RFID reader 101 and other RFID readers and the interpretive program for filtering the data.

It should be noted that although the data integration device 100 already has the first memory 122, the second memory 123, and the clock circuit 124, for buffering the transmitting or receiving of a large amount of the first data and the second data, the processor 114 may also filter the undesired first data so as to save the processing time and avoid generating the undesired second data. Therefore, the processor 114 is more efficient and the data transmission between the communication interface 111 and the output interface 112 may be more fluent.

In view of the above, in the embodiment of the present invention, the central control chip in the processor 114 may be used to record the interpretive program and the communication protocols and the control instructions of the RFID readers manufactured by any factory and to process the first data captured by the RFID readers manufactured by any factory without additionally developing the user interface program or spending labor and time to integrate the user interface programs of different brands when a plurality of RFID readers are used. The display device 121 may achieve the effect of real-time control. The first memory 122, the second memory 123, the clock circuit 124, and the processor 114 may be used for buffering and filtering a large amount of data. The serial communication interface 141 may communicate with the externally connected first RFID reader data integration device 200 to achieve the effect of overall control.

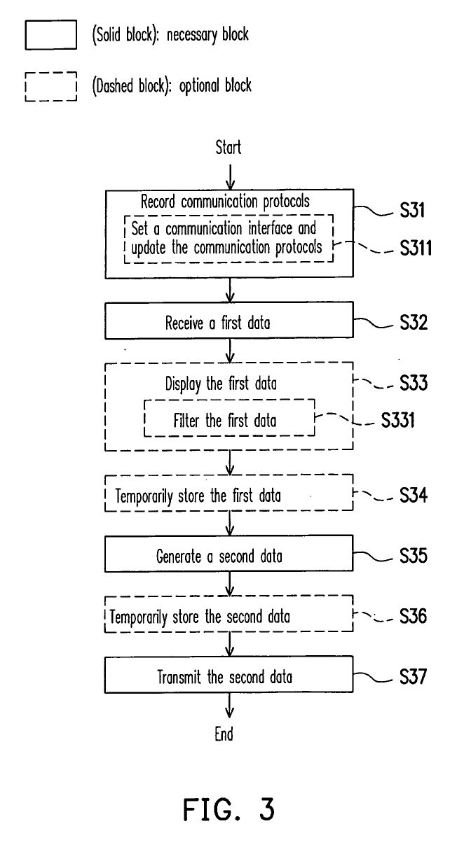

Referring to FIG. 3, FIG. 3 is a schematic view illustrating processes of an RFID reader control method according to an embodiment of the present invention.

The method includes the following steps. In step (S31), communication protocols, control instructions and interpretive program are recorded. That is, the communication protocols and the control instructions of a plurality of RFID readers and the interpretive program for filtering the data are recorded in a central control chip. An input interface may be used to achieve the recording or updating of the data in the central control chip. That is, in step (S311), the communication interface is set and the communication protocols, the control instructions, and the interpretive program are updated. Thus, the control method may update and record the RFID readers and their communication protocols, control instructions, and the interpretive program in the step (S311). In step (S32), the first data is received, i.e., the first data of the RFID readers is received via the communication interface. The communication interface may be set through the step (S311). In step (S33), the first data is displayed, i.e., the data carried by the first data is displayed. Through this step, the effect of real-time monitoring may be achieved. The step (S33) is also accompanied with the step (S331) of filtering the first data, i.e., after filtering the undesired first data, the load to be processed in subsequent steps may be reduced. In step (S34), the first data is temporarily stored, i.e., after filtering the undesired first data, the desired first data is stored and an operating time for temporarily storing the first data and transmitting or receiving the first data is controlled to achieve the buffering effect. In step (S35), a second data is generated, i.e., the processor will perform a data processing on the first data to generate the second data according to the interpretive program recorded in the central control chip and to control an operating time for generating the second data, so as to achieve the buffering effect. In step (S36), the second data is temporarily stored, i.e., the generated second data is stored and an operating time for temporarily storing the second data and transmitting or receiving the second data is controlled to achieve the buffering effect. In step (S37), the second data is transmitted, i.e., when the output interface is available, the temporarily stored second data is transmitted to a back-end terminal machine to perform the final processing and storage.

The operating frequency bands of the RFID readers in the step (S31) are not intended to limit the scope of the present invention. The communication interface in the step (S32) may be an RS232 interface, an RS485 interface, or a network interface. However, the implementation of the communication interface is not intended to limit the scope of the present invention.

In addition, the control method further provides a serial communication interface. As long as the externally connected first RFID reader data integration device also provides a first serial communication interface, the control method may enable the plurality of data integration devices to communicate, so as to achieve the effect of overall control.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A radio frequency identification (RFID) reader data integration device, for controlling at least one RFID reader, comprising:
a communication interface, for communicating with the RFID reader;
an output interface, for outputting a second data;
a transceiver, coupled to the communication interface and the output interface, for receiving a first data sent by the RFID reader and transmitting the second data to the output interface; and
a processor, coupled to the transceiver and comprising a central control chip, wherein the central control chip is used for recording an interpretive program and communication protocols and control instructions of the RFID reader, the processor is used for receiving the first data according to the communication protocols and the control instructions of the RFID reader and performing a data processing on the first data to generate the second data by the interpretive program.

2. The RFID reader data integration device according to claim 1, further comprising:
at least one serial communication interface, for communicating with a first RFID reader data integration device externally connected thereto, wherein the first RFID reader data integration device comprises at least one first serial communication interface.

3. The RFID reader data integration device according to claim 1, further comprising:
a display device, coupled to the processor, for displaying information of the RFID reader carried in the first data.

4. The RFID reader data integration device according to claim 1, further comprising:
a first memory, coupled to the processor, for temporarily storing the first data;
a second memory, coupled to the processor, for temporarily storing the second data; and
a clock circuit, coupled to the first memory, the second memory, the processor, and the transceiver, for controlling an operating time of the first memory, the second memory, the processor and the transceiver.

5. The RFID reader data integration device according to claim 1, further comprising:
an input interface, coupled to the processor, for setting the communication interface, such that the communication interface communicates with the RFID reader, and for updating the interpretive program and the communication protocols and the control instructions of the RFID reader recorded by the central control chip.

6. The RFID reader data integration device according to claim 1, wherein the central control chip is further used for recording the communication protocols and the control instructions of two or more different RFID readers, and the data processing comprises filtering a large amount of the first data to generate the second data.

7. The RFID reader data integration device according to claim 1, wherein the communication interface is a recommended standard 232 (RS232) interface, a recommended standard 485 (RS485) interface, or a network interface.

8. The RFID reader data integration device according to claim 1, wherein the processor is further used for filtering the first data which is not required.

9. The RFID reader data integration device according to claim 1, wherein the output interface is linked to an externally connected terminal machine.

10. A RFID reader control method, comprising:
providing a central control chip for recording an interpretive program and communication protocols and control instructions of a plurality of different RFID readers;
providing a communication interface for communicating with the RFID reader to receive a first data of the RFID reader;
converting the first data to generate a second data according to the interpretive program; and
outputting the second data.

11. The RFID reader control method according to claim 10, further comprising:
providing at least one serial communication interface for communicating with a first RFID reader data integration device externally connected to the serial communication interface, wherein the first RFID reader data integration device comprises at least one first serial communication interface.

12. The RFID reader control method according to claim 10, further comprising:
displaying information of the RFID reader carried in the first data.

13. The RFID reader control method according to claim 10, further comprising:
temporarily storing the first data;
temporarily storing the second data; and
controlling an operating time for temporarily storing the first data and the second data, generating the second data, and transmitting or receiving the first data and the second data.

14. The RFID reader control method according to claim 10, further comprising:
providing an input interface to set the communication interface, such that the communication interface communicates with the RFID reader; and
updating the communication protocols and the control instructions of the RFID reader and the interpretive program recorded by the central control chip.

15. The RFID reader control method according to claim 10, wherein the communication interface is an RS232 interface, an RS485 interface, or a network interface.

16. The RFID reader control method according to claim 10, further comprising:
filtering the first data which is not required.
